(19) United States
(12) Patent Application Publication
(10) Pub. No.: US 2026/0241403 A1
(43) Pub. Date: Aug. 20, 2026

(54) AERIAL LIFT PAINT SPRAY CONTAINMENT DEVICE

(71) Applicant: Vigor Industrial LLC, Portland, OR (US)

(72) Inventors: Scott Fischer, Portland, OR (US); Bless Tive, Portland, OR (US)

(73) Assignee: Vigor Industrial LLC, Portland, OR (US)

(21) Appl. No.: 19/057,713

(22) Filed: Feb. 19, 2025

(51) Int. Cl. B05B 12/32; B05B 12/18; B66F 17/00

(52) U.S. Cl. CPC B05B 12/32; B05B 12/18; B66F 17/006

(57) ABSTRACT

A paint containment device for an aerial lift can include a cover, a frame, and one or more exhaust apparatus. One or more exhaust fans can be disposed within the one or more exhaust apertures. One or more filters may be deposited within an opening of the one or more exhaust apertures. The exhaust fans can draw air and airborne paint from inside of the cover through the one or more filters and exhaust it out of the one or more exhaust apertures.

### FIELD

The present disclosure concerns examples of apparatus and methods for containing paint spray while painting using an aerial lift.

### BACKGROUND

Painting large surfaces can be accomplished with a paint spraying apparatus. Painting with such an apparatus can sometimes result in overspray. Overspray is paint, varnish, or other material that drifts away from its intended target during a painting or blasting operation and may contaminate the surrounding area. Overspray can, in some instances, be an environmental hazard (e.g. pollute the marine environment), damage property, and/or create a fire hazard. Areial lifts are often used along with paint spraying apparatus in industrial paining (e.g., for painting the hull of a ship in a drydock) for their mobility and ease of reaching out of the way surfaces. A user can be positioned in the basket of an aerial lift with a paint spraying apparatus while another user can control the motion of the aerial lift.

During a drydocking period for a ship, painting the hull can be a critical aspect of a successful dry docking. This process can help protect the ship from corrosion and improve performance and efficiency. Proper hull painting not only helps to safeguards structural integrity of the ship but can also increases hydrodynamic efficiency which can result in a reduction in fuel consumption. Due to the proximity to the marine environment and environmental concerns, reduction of overspray can be particularly important in shipyards.

### SUMMARY

Described herein are paint containment devices for aerial lifts and methods of use. The disclosed paint containment devices can for example reduce the environmental effects of paint overspray. As such, the paint containment devices and methods of use disclosed herein can, among other things, overcome one or more of the deficiencies of typical painting methods.

In some examples, a paint containment device for an aerial lift vehicle comprises: a frame configured to be coupled to the aerial lift vehicle; a cover with an open working portion and one or more exhaust apertures, wherein the open working portion is configured to be position towards a surface to be painted; and one or more exhaust fans positioned within the one or more exhaust apertures wherein the exhaust fans are configured to draw air and paint through the open working portion into the exhaust apertures.

In some examples, the paint containment device further comprises one or more filters disposed over the one or more exhaust apertures and configured to remove the paint from air entering the exhaust fans. In some examples, the one or more filters comprise fiberglass filters. In some examples, a filter support lip is disposed around each of the one or more exhaust apertures wherein the one or more filters are removably coupled to the filter support lip. In some examples, the filter is disposed at an angle within a range of 30 to 60 degrees relative to horizontal.

In some examples, the paint containment device comprises two exhaust fans positioned within two exhaust apertures. In some examples, the two exhaust fans are positioned on either side of a centerline of the paint containment device. In some examples, at least a portion of the cover comprises a transparent material. In some examples, each of the one or more exhaust fans has a capacity in a range of 2,000 CFM to 4,000 CFM.

In some examples, a paint containment device comprises: a lower portion configured to attach to a basket of an aerial lift vehicle; an upper portion coupled to the lower portion and comprises: a cover; an open working portion configured to be position towards a surface to be painted; and one or more exhaust apertures, where the one or more exhaust apertures extend through the cover. In some examples, the paint containment device further comprises one or more exhaust fans positioned within the one or more exhaust apertures.

In some examples, the paint containment device further comprises one or more filters positioned over the one or more exhaust apertures. In some examples, the paint containment device, further comprises a filter support element configured to prevent the filter from deforming towards the exhaust fan. In some examples, the upper portion of the paint containment device further comprises a filter support lip and the one or more filters are removably coupled to the filter support lip. In some examples, the one or more filters are coupled to the filter support lip by hook and loop. In some examples, the upper portion of the cover comprises a transparent material.

In some examples, a method of painting using a containment device on an aerial lift comprises: spraying paint out of an open working portion of the paint containment device; drawing air and paint into the open working portion; and exhausting the air and paint out through one or more exhaust apertures using one or more exhaust fans.

In some examples, the method further comprises filtering the paint out of the air using one or more filters before exhausting it. In some examples, the method further comprises replacing the one or more filters when a preselected criteria is met. In some examples, the preselected criteria is a period of operational time within in a range of 1 hour to 5 hours.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-1C show perspective views of a paint spray containment device, according to one example.

FIG. 2 shows a frame for the paint spray containment device.

FIG. 3 shows the frame for the paint containment device installed in a basket of an exemplary aerial lift vehicle.

FIG. 4 depicts an exemplary aerial lift vehicle for use with the paint spray containment device.

### DETAILED DESCRIPTION

### General Considerations

For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used herein, “e.g.” means “for example,” and “i.e.” means “that is.”

### Examples of the Disclosed Technology

Painting from an aerial lift vehicle can allow a user to reach out of the way areas and can speed up the rate of painting large areas. The paint containment devices described herein can have several advantages including reducing overspray, which can have benefits to the environment, decrease the risk of applying paint to unintended targets, and/or reduce risk of fire. The paint containment device described herein can also be easy for a user to install and operate. Some features of the paint containment device may help increase user visibility during painting operations.

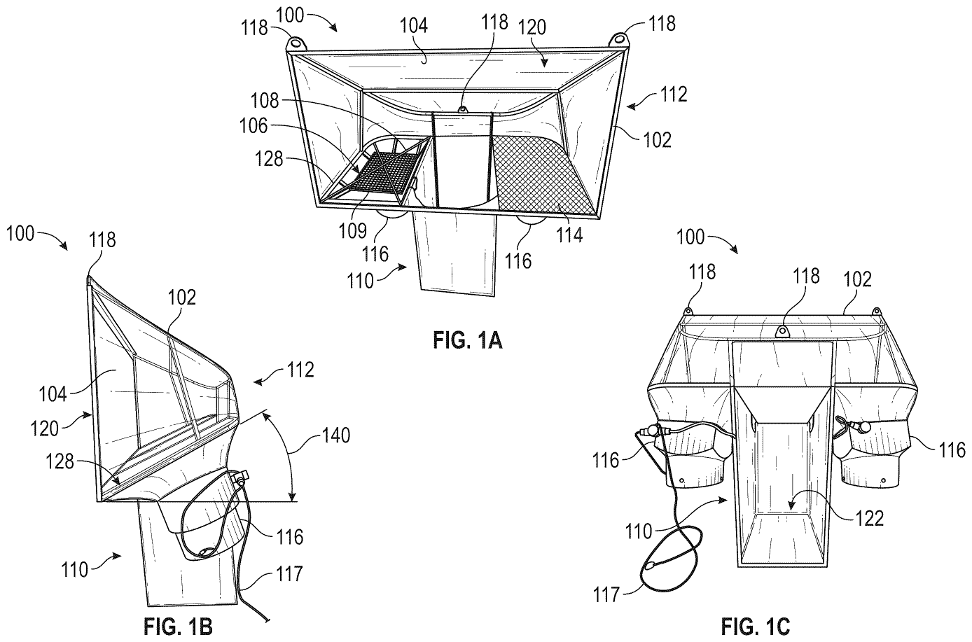

FIGS. 1A-1C depict a paint containment device 100. The paint containment device 100 can, for example, be used with an aerial lift vehicle. The paint containment device 100 comprises a frame 102, a cover 104, filters 114, and exhaust fans 116. The frame 102 is configured to support the cover 104, the filters 114, and exhaust fans 116. The frame 102 can also be used for removably coupling the paint containment device 100 to an aerial lift (e.g., the basket of the aerial lift). The cover 104 can be configured to direct the overspray toward the filters 114. The filters 114 can capture the paint within the overspray and allow the air to pass therethrough. The exhaust fans 116 can generate directional airflow into the paint containment device 100 and through the filters 114.

The cover 104 can comprise a piece of material disposed over the frame. The cover 104 can define an open working portion 120 and one or more exhaust apertures 106. The open working portion 120 can be configured to be position towards a surface to be painted and a user can spray paint through the open working portion 120. The paint containment device 100 can also include one or more exhaust fans 116 positioned within the one or more exhaust apertures 106. The paint containment device 100 can comprise a first portion 110 (also referred to as the “lower portion”) and a second portion 112 (also referred to as an “upper portion”). The first portion 110 of the containment device 100 can be configured to attach to an aerial lift basket and can also define a cockpit area 122 in which a user can stand. The second portion 112 of the containment device 100 can define an operational area and can support the exhaust fans 116 in their operational positions. The operational area defined by the second portion 112 can be larger in a horizontal direction than the first portion 110, which can allow the user additional freedom to move around while painting.

In some examples, the cover 104 comprises a plastic material. In some examples, the plastic material is a clear plastic with a thickness in a range of 3 mils to 6 mils. In some examples, the first portion 110 comprises a cover 104 constructed of a translucent material and the second portion 112 comprises a cover 104 constructed of a transparent material. In some examples, both the first portion 110 and the second portion 112 comprise a cover 104 that is a transparent material. In some examples, both the first portion 110 and the second portion 112 comprise a cover 104 that is a translucent material. In some examples, having a cover 104 which partially or fully comprises a transparent material has the advantage of increasing user visibility, and therefore safety, during painting operations.

The one or more exhaust fans 116 can be configured to draw air and airborne paint from inside of the cover 104 and exhaust it out of the one or more exhaust apertures 106. In other words, the one or more exhaust fans 116 can cause a negative pressure differential between the air inside the cover 104 and the air outside of the cover 104, this can cause air and paint to be drawn in through the open working portion 120 and to then pass through the exhaust apertures 106. In some examples, the exhaust fans 116 can each have a capacity in a range of 100 CFM to 10,000 CFM, a range of 1,000 CFM to 6,000 CFM a range of 2,000 CFM to 4,000 CFM. In one example the exhaust fans 116 each have a capacity of 3000 CFM.

In some examples, the exhaust fans 116 can be electrical fans and can comprise an electric cable 117 which delivers electricity to the one or more exhaust fans 116. In some examples, the electrical cable 117 can be connected to an electrical connection on the aerial lift. In some examples, the electrical cable 117 can be electrically coupled to a source of electricity built into the aerial lift vehicle or can be electrically coupled to a source of electricity separate from the aerial lift vehicle. In the depicted example, the one or more exhaust fans 116 comprises two exhaust fans 116 positioned within two exhaust apertures 106. The two exhaust fans 116 are positioned on either side of a centerline of the paint containment device 100. In some examples, the exhaust fans can comprise aluminum blades to reduce sparking risk. In some examples, the exhaust fans can comprise an anti-static polyethylene housing for safety and corrosion resistance. In some examples, the exhaust fan can comprise a direct drive hazardous location exhaust fan such as those offered by Schaefer Ventilation.

As depicted in FIG. 1A, a filter 114 can be deposited within an opening of the exhaust aperture 106 positioned towards the open working portion 120. In other words, the filter 114 can be disposed between the open working portion 120 and the exhaust fan 116. In some examples, the exhaust fans 116 can be configured to draw air and aerosolized paint through the open working portion 120, through the filter 114, and into the exhaust apertures 106 and exhaust air out the back of the exhaust fan 116 while retaining all or a portion of the aerosolized paint, which is deposited on the filter 114. In other words, the filter 114 can remove the paint from air entering the exhaust fans 116. In some examples, the filter 114 can be a paint booth exhaust filters, such as a fiberglass filters. In some examples, the filter media can be another material which can be chosen based on the aerosolized material to be filtered out of the air and/or the cleanliness of the air required on the exhaust side of the system.

As depicted in FIG. 1B, the filter 144 can be coupled to a filter support lip 128 which can extend along the perimeter of the exhaust aperture 106 and define a plane. The plane defined by the filter support lip 128 can be angled relative to the horizontal direction by an angle 140. In some examples, the angle 140 is in a range of 20 to 70 degrees, in some examples in a range of 30 to 60 degrees, in some examples, in a range of 40 to 50 degrees. In some examples, the angle 140 is 45 degrees. Having the filter support lip 128 at an angle can result in the filter 114 to be supported at the angle 140. In some examples, having a filter disposed at an angle 140 can have the advantage of capturing more paint than either a filter disposed in a horizontal or vertical plane.

In some examples, the filter 114 can be removably coupled to the filter support lip 128 which has the advantage of making it easier for the user to change the filter 114 when it reaches its operation life, e.g. after a predetermined time, after a predetermined painted area, and/or when it becomes partially or fully saturated with paint. In some examples, the filter 144 can be removably coupled to the filter support lip 128 by one or more strips of hook and loop material (i.e., Velcro™) where one portion of the hook and loop (e.g. the hook portion) is disposed on the filter support lip 128 and the opposite portion of the hook and loop (e.g. the loop portion) is disposed on the filter 114. In some examples, the filter 114 can be removably coupled to the lip 128 by a semi-permanent connection, such as by screws, pins, bands, straps, and or clamps. Having the filter 114 be removably coupled to the filter support lip 128 can have advantages such as reducing the time to change filters. In some examples, the one or more filters may be replaced when a preselected criteria is met. In some examples, the preselected criteria is a preselected period of operational time within in a range of 1 hour to 24 hours, a range of 1 to 10 hours, or a range of 1 to 5 hours. In some examples, the preselected criteria is a measurement of air flow rate, a measurement of differential pressure across the filter, an area of paint applied, and/or another criteria.

The exhaust apertures 106 can comprise one or more features which may help to support the filter 114. A filter support element 108 can extend fully or partially over the plane of the exhaust aperture 106 defined by the filter support lip 128 and can provide support to the filter 114. In some examples, the filter 114 may be made of a pliable material which has the potential to deform as the exhaust fan pulls air through the filter 114. In the depicted example, the filter support element 108 comprises one or more cross bars which extend across the exhaust aperture 106. The filter 114 can rest on these cross bars (either in a rest state or when the exhaust fan 116 exerts a suction force on the filter 114) with the result that the filter can be prevented from deforming (i.e. experiences less deformation) in the direction of air movement when the exhaust fan 116 is operated. In some examples, the filter support element can be a series of cross bars which extend across the exhaust aperture parallel to one another. In some examples, the filter support apparatus can comprise a screen or a sheet of material with a plurality of holes.

In some examples, the exhaust apertures 106 can comprise one or more features which may reduce the risk of damage to the exhaust fan 116. The exhaust aperture 106 can comprise a screening element 109 which can be disposed over an inlet of the exhaust fan 116. The screening element 109 can help to ensure that foreign objects do not get sucked into the exhaust fan 116 and can reduce the likelihood of solid materials striking the blades of the exhaust fan 116. This can reduce the likelihood of damage to the exhaust fan blades. In the example depicted in FIG. 1A, the screening element 109 comprises a grate. In some examples, the screening element can comprise a metal or plastic screen or a sheet of material with a plurality of holes.

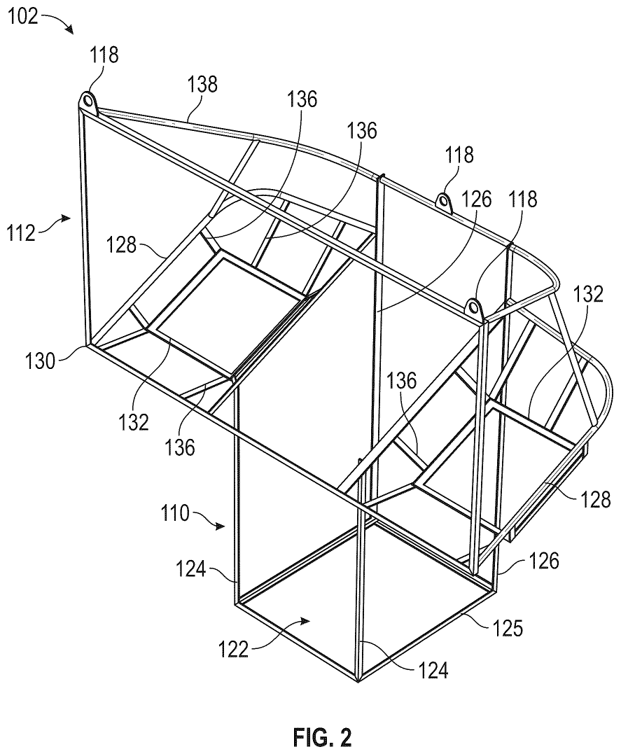

FIG. 2 depicts the frame 102 with the cover 104 and exhaust fans 116 removed. The frame 102 can provide structural integrity to the cover 104 and can support the exhaust fans 116. The frame 102 can be configured to be coupled to an aerial lift vehicle. In some examples, the frame 102 is configured to be inserted into the basket of an aerial lift vehicle. The frame can have portions corresponding to the first portion 110 and the second portion 112 of the paint containment device 100. In some examples, the frame comprises aluminum. In some examples, the frame comprises another metal, for example, steel. In some examples, the fame comprises metal and/or non-metal material such as wood, fiberglass, and/or polymer.

The portion of the frame 102 which defines first portion 110 of paint containment device 100 can comprise a base 125 and one or more first vertical support 124 and one or more second vertical supports 126. The first vertical supports 124 and the second vertical supports 126 can provide support to the second portion 112 of the frame 102. The area defined by the base 125, first vertical supports 124, and second vertical supports 126 can also define cockpit area 122 in which the user can stand. In the depicted example there are two first vertical supports 124 and two second vertical supports 126 and the second vertical supports 126 are longer than the first vertical supports 124. The second vertical supports 126 can define an entry through which the user can access the cockpit 122. In some examples, there is an additional cover that covers the area between the second vertical supports 126 to create a “door” to the cockpit 122. The first portion 110 of the frame 102 can be configured to fit within the basket of an aerial lift vehicle.

The portion of the frame 102 which defines second portion 112 of paint containment device 100 can comprise a frame 130, a roof support 138, and one or more exhaust portions. The one or more exhaust portions can each comprise the filter support lip 128, an exhaust fan support frame 132 and one or more struts 136 which can couple the exhaust fan support frame 132 to the filter support lip. The frame 130 defines the open portion 120 through which the user sprays paint. In the depicted example, the frame 130 is rectangular, in some examples, the frame 130 can be oval, circular, square, or another shape. The roof support 138 can be coupled to the frame 130 and to the two second vertical supports 126. In some examples, the roof support may comprise one or more lifting rings 118 which can be configured to provide connection points to attach a lifting apparatus, for example, a forklift or a crane.

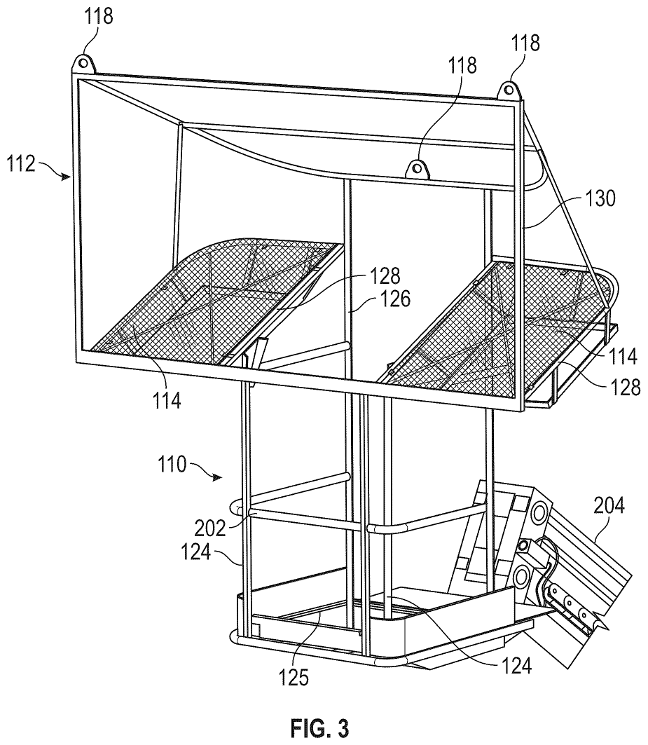

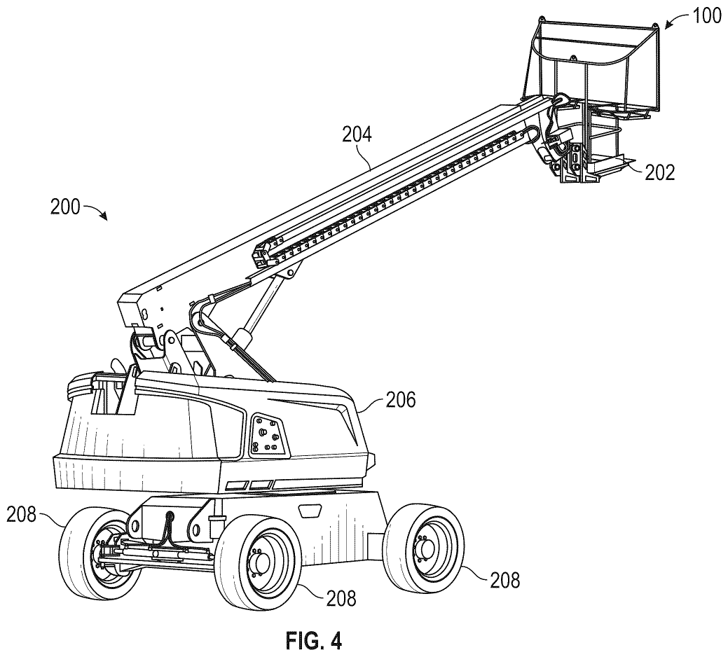

FIG. 3 depicts a paint containment device 100 with the cover 104 and exhaust fans 116 removed for ease of illustration. The paint containment device 100 is installed in a basket 202 of an aerial lift vehicle, such as the aerial lift vehicle 200 (FIG. 4). In some examples, the frame 102 including the base 125, first vertical supports 124, and/or second vertical supports 126 can be coupled to the basket 202 of the aerial lift vehicle 200. The frame 102 may be coupled to the basket 202 by a permanent or a semi-permanent connection, such as by zip ties, screws, bolts, pins, bands, straps, clamps, and/or other means for connecting.

Depicted in FIG. 4 is an exemplary aerial lift vehicle 200 for use with the paint spray containment device. As depicted, the aerial lift vehicle 200 may comprise the basket 202, the boom 204, a base portion 206, and one or more wheels 208. The depicted aerial lift vehicle comprises an extendable boom, however, the paint containment device described herein can be used with another similar areal lift vehicle such as an aerial ladder vehicle, a bucket truck, a scissor lift vehicle, or any other vehicle designed to allow a user to reach an elevated position.

The paint containment device described herein may have several advantages including reducing overspray, which can have benefits to the environment, decrease the risk of applying paint to unintended targets, and/or reduce risk of fire. The paint containment device described herein can also be easy for a user to install and operate.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A paint containment device for an aerial lift vehicle, the containment device comprising:
a frame configured to be coupled to the aerial lift vehicle;
a cover with an open working portion and one or more exhaust apertures, wherein the open working portion is configured to be position towards a surface to be painted; and
one or more exhaust fans positioned within the one or more exhaust apertures
wherein the exhaust fans are configured to draw air and paint through the open working portion into the exhaust apertures.

2. The paint containment device of claim 1, further comprising one or more filters disposed over the one or more exhaust apertures and configured to remove the paint from air entering the exhaust fans.

3. The paint containment device of claim 2, wherein the one or more filters comprise fiberglass filters.

4. The paint containment device of claim 2, further comprising a filter support lip disposed around each of the one or more exhaust apertures wherein the one or more filters are removably coupled to the filter support lip.

5. The paint containment device of claim 2, wherein the filter is disposed at an angle within a range of 30 to 60 degrees relative to horizontal.

6. The paint containment device of claim 1, comprising two exhaust fans positioned within two exhaust apertures.

7. The paint containment device of claim 6 wherein the two exhaust fans are positioned on either side of a centerline of the paint containment device.

8. The paint containment device of claim 1, wherein at least a portion of the cover comprises a transparent material.

9. The paint containment device of claim 1, wherein each of the one or more exhaust fans has a capacity in a range of 2,000 CFM to 4,000 CFM.

10. A paint containment device comprising:
a lower portion configured to attach to a basket of an aerial lift vehicle;
an upper portion coupled to the lower portion and comprising:
a cover;
an open working portion configured to be position towards a surface to be painted; and
one or more exhaust apertures, where the one or more exhaust apertures extend through the cover.

11. The paint containment device of claim 10, further comprising one or more exhaust fans positioned within the one or more exhaust apertures.

12. The paint containment device of claim 10, further comprising one or more filters positioned over the one or more exhaust apertures.

13. The paint containment device of claim 12, further comprising a filter support element configured to prevent the filter from deforming towards the exhaust fan.

14. The paint containment device of claim 12, wherein the upper portion of the paint containment device further comprises a filter support lip and the one or more filters are removably coupled to the filter support lip.

15. The paint containment device of claim 14, wherein the one or more filters are coupled to the filter support lip by hook and loop.

16. The paint containment device of claim 10, wherein the upper portion of the cover comprises a transparent material.

17. A method of painting using a containment device on an aerial lift, the method comprising:
spraying paint out of an open working portion of the paint containment device;
drawing air and paint into the open working portion; and
exhausting the air and paint out through one or more exhaust apertures using one or more exhaust fans.

18. The method of claim 17, further comprising filtering the paint out of the air using one or more filters before exhausting it.

19. The method of claim 18, further comprising replacing the one or more filters when a preselected criteria is met.

20. The method of claim 19, wherein the preselected criteria is a period of operational time within in a range of 1 hour to 5 hours.
